(19) United States
(12) Patent Application Publication
(10) Pub. No.: US 2020/0393049 A1
(43) Pub. Date: Dec. 17, 2020

(54) WATER CONTROL DEVICE

(71) Applicant: MILLARD M. MINTON, JR., ROARING RIVER, NC (US)

(72) Inventor: MILLARD M. MINTON, JR., ROARING RIVER, NC (US)

(21) Appl. No.: 16/439,787

(22) Filed: Jun. 13, 2019

(51) Int. Cl. F16K 5/04; F16K 31/42; F16K 3/02; F16K 31/46; F16K 1/30

(52) U.S. Cl. CPC F16K 5/0428; F16K 31/42; F16K 31/52425; F16K 31/46; F16K 1/304; F16K 3/0209

(57) ABSTRACT

A water control device that can be introduced into the main water supply line for a structure configured for automatic direct water allocation has a manifold with an inlet port and an outlet port in fluid communication with one another and a quarter turn valve disposed between the inlet and outlet ports and in fluid communication therewith. The quarter turn valve has a truncated conical shaped valve body that fits within a well in the manifold, the valve body having spaced apart solid side walls which define openings within opposite side walls, such that rotation of the valve body by a quarter turn will align either an opening or a solid side wall with the inlet and outlets ports for the well, thus alternately permitting or disrupting the flow of water through the valve. The valve body further includes a plurality of spaced apart cam projections on a bottom surface thereof, the cam projections cooperating with a plurality of spaced apart cam projections disposed on a bottom surface of the well such that the valve body undergoes vertical displacement as it rotates.

### FIELD OF THE INVENTION

The invention herein pertains to water management and preservation systems and particularly pertains to a water control device that utilizes a quarter turn valve that is vertically displaced upon rotational movement to open and close the valve.

### DESCRIPTION OF THE PRIOR ART AND OBJECTIVES OF THE INVENTION

Water leaks in homes and businesses cause a tremendous amount of expense and damage to the structure. Leaks can occur in numerous places throughout a residential or commercial structure, often in locations that are inaccessible or undetectable by an occupant. Leaks of this kind can cause significant damage even if it is discovered quickly, but the longer the leak exists, the greater the damage may be.

It is thus a generally prudent idea to shut off the water supply into a structure whenever there is no immediate demand for water. However, in most structures it is quite inconvenient to turn water on at the main inlet whenever a faucet, washing machine, dishwasher or toilet is to be used and turn it back off when the need for water is abated. This is particularly problematic where the main water inlet into the structure might be located in a crawl space, closet, attic, or other location that is not readily accessible. It is also prudent to at least shut off the water supply when the structure will remain unoccupied for a period of time, such as when the occupants are on vacation, or away at work or school. Even this practice, however can be problematic if the main water valve is not in a readily accessible place. Further, remembering these critical steps is often a challenge

As a result, several devices have been proposed for remote operation of the water supply valve that permit the user to open and close the water valve from a remote location using a wired or wireless connection, or by an app on a smart phone. In general, these prior art devices use a motor that is in operative contact with a quarter turn ball valve. When the motor is actuated, it mechanically operates the lever on the quarter turn ball valve to open or close the valve. Many such devices, particularly those that operate by a wireless signal, offer an ability to incorporate sensors throughout the structure which, when the sensor detects the presence of water, will operate the motor to shut off the water supply, thus preventing damage to the structure from a leak.

There is a need for a simplified water control device that can be introduced into the main water supply line for a structure, which can integrate a quarter turn valve with a flow meter and can be operated remotely, or in the alternative, be configured to automatically open and close the valve as needed to regulate water flow into the structure.

It is thus an objective of the invention to provide a unitary water control device having a quarter turn valve that can be introduced into the main water supply for a structure.

It is a further objective of the invention to provide a unitary water control device that integrates a water control valve and flow meter into a single module.

It is another objective of the invention to provide a unitary water control device that can be introduced into the main water supply for a structure that has a remote actuated quarter turn valve.

It is a further objective of the invention to provide a unitary water control device that can be introduced into the main water supply line of a structure, in which a quarter turn valve comprises a truncated conical shaped valve body.

It is yet another objective of the invention to provide a water control device having a quarter turn valve, the quarter turn valve having a truncated conical shaped valve body and wherein a quarter turn of the valve body creates rotational and vertical movement of the valve body.

It is an additional objective of the present invention to provide a water control device with a quarter turn valve in communication with a valve body including one or more cammed surfaces positioned within the manifold housing, the one or more cammed surfaces configured to frictionally disassociate from the housing surface or components thereof.

It is a further objective of the present invention to provide a water control device with a quarter turn valve in communication with a valve body including one or more cammed surfaces defining a low coefficient of friction relative to the manifold housing and components thereof, thereby facilitating the frictional disassociation described above.

Various other objectives and advantages of the present invention will become apparent to those skilled in the art as a more detailed description is set forth below.

### SUMMARY OF THE INVENTION

In a preferred embodiment, the water control device has a unitary module that can be introduced into the main water supply line for a structure configured for automatic direct water allocation, meaning that the flow of water through the water control device is authorized or permitted only when a valid need for water through the device is detected. The module has an inlet port and an outlet port in fluid communication with one another via a conduit in between. Disposed between the inlet and outlet ports is a quarter turn valve. A flow meter is preferably disposed between the valve and the outlet port. The quarter turn valve may be actuated manually but the device preferably includes a motor which can be automatically and/or remotely operated to open or close the valve. The quarter turn valve defines a truncated conical shaped valve body that fits within a well in the manifold. Specifically, the valve body includes openings within opposite side walls such that rotation of the valve body by a quarter turn will align either an opening or a solid side wall with the inlet and outlets ports for the well, thus alternately permitting or disrupting the flow of water through the valve. The valve body further defines a plurality of spaced apart cam projections on a bottom surface thereof, the cam projections frictionally cooperating with a plurality of spaced apart cam projections disposed on a bottom surface of the well such that the valve body undergoes a frictional separation between the respective cam projections, leading to vertical and horizontal displacement of the valve cam projections as the valve rotates.

### BRIEF DESCRIPTION OF THE DRAWINGS

FIG. 1 is an exploded perspective view of a preferred embodiment of the water control device, showing the water valve module used in conjunction with a water filtration module, flow meter, pressure tank, and motor for remote or automatic actuation of the quarter turn valve.

FIG. 2 is a perspective view of the top side of the water valve module.

FIG. 3 is a perspective view of the bottom side of the water valve module.

FIG. 4 is a schematic cross-sectional view of the water valve.

FIG. 5 is a perspective view, partly in phantom, of the truncated conical shaped valve body.

### DETAILED DESCRIPTION OF THE PREFERRED EMBODIMENT AND OPERATION OF THE INVENTION

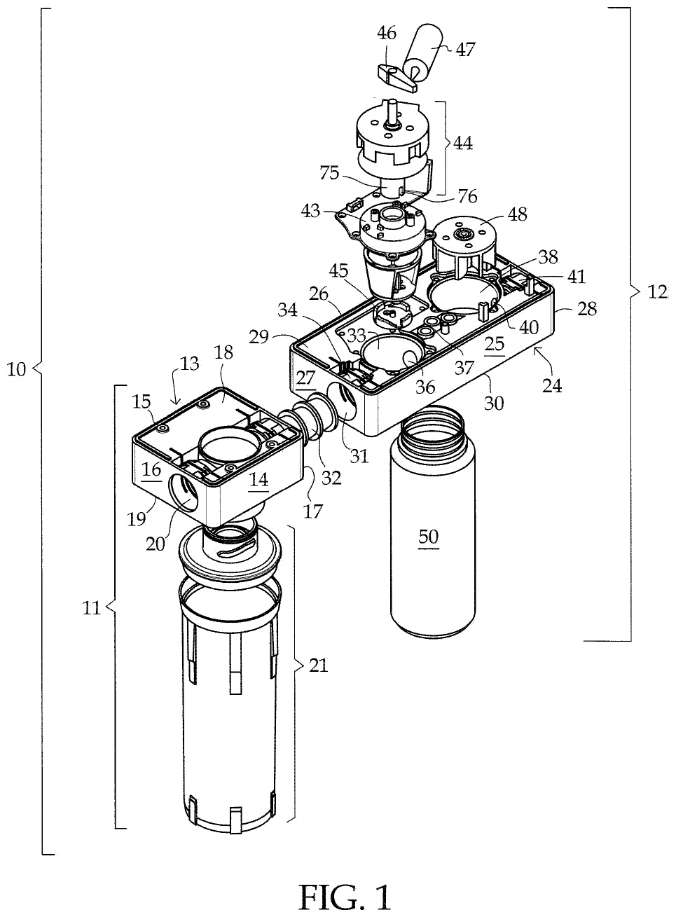

Referring to FIG. 1, a preferred implementation of the water control device of the invention is shown therein as part of a water control and filtration system generally designated as 10. This system is preferably considered a direct water allocation system, in that the system only permits water to enter the structure when water is needed; otherwise the default position of the system prevents the entry of any water into the structure. The system shown in FIG. 1 has a water filtration module 11 deployed in conjunction with a water valve module 12. The water filtration module 11 is defined by a manifold 13. The manifold 13 preferably has a box shape, having a front wall 14, rear wall 15, left side 16, right side 17, top 18 and bottom 19. On the left side 16 of manifold 13 is defined an inlet port 20 that is configured to be connected to the main water supply line for the structure (not shown) and/or hardware facilitating such a connection. A water filtration cartridge 21 is ideally attached to the bottom 19 of manifold 13 in any known manner, for example threaded engagement, mechanical fastener engagement, temporary adhesive engagement, or the like. As water flows into the structure, it is filtered by the cartridge 21 and then exits through outlet port (not shown) on the left side 17 of the manifold 13.

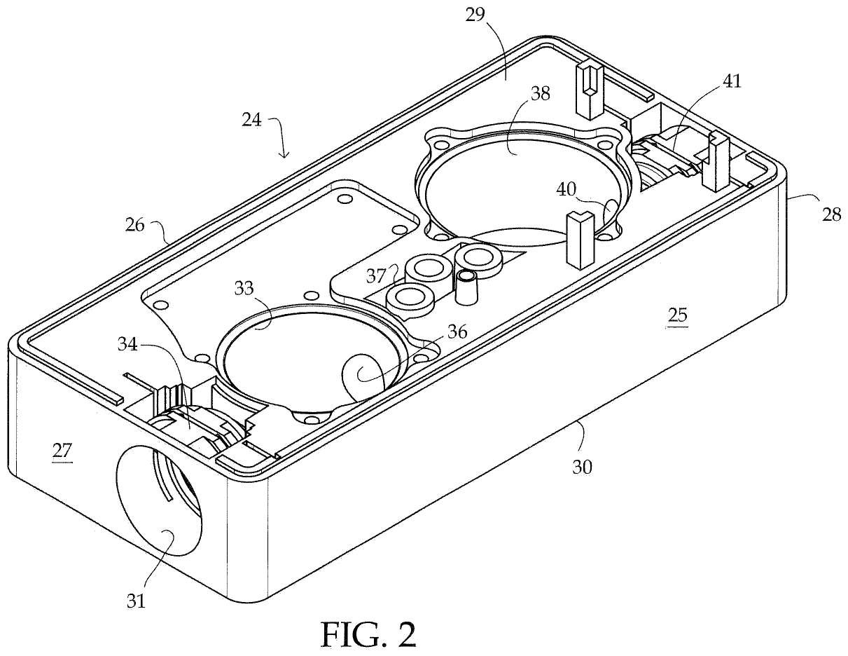

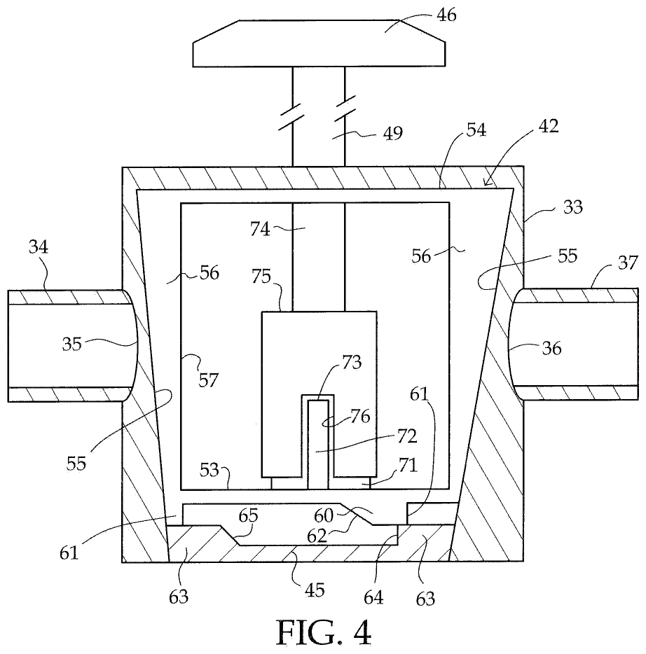

With reference to FIGS. 1-4, valve module 12 preferably includes a manifold 24 which is also of box like configuration and has a front wall 25, rear wall 26, left wall 27, right wall 28, top 29 and bottom 30. The left wall 27 of manifold 24 may define an inlet port 31, which is in fluid communication with the outlet port (not shown) of manifold 13 via fluid conduit 32. Preferred inlet port 31 is in fluid communication with valve well 33 via conduit 34, which terminates into inlet port 35 (FIG. 4) of valve well 33. The opposing side of valve well 33 includes an outlet port 36, which connects with conduit 37 to provide fluid communication between valve well 33 and flow meter well 38. Flow meter well 38 may include an inlet port (not shown) and an outlet port 40. Outlet port 40 is in fluid communication with conduit 41, which in turn is in fluid communication to a water supply pipe (not shown) for the structure, or hardware to facilitate the same.

As shown in FIG. 1 in particular, preferred water valve module 12 further includes a valve body 42, valve cover 43, motor assembly 44, cam ring 45, handle 46, electronic actuator 47 and impeller 48. The impeller 48 may fit within flow meter well 38 and generally functions to measure the flow of water through the water valve module 12. In the embodiments, the valve body 42 may be rotated by manual manipulation of handle 46 or by motor assembly 44 acting on shaft 49 (FIG. 4) to rotate valve body 42 in predetermined increments, for example quarter turn increments to open or close the valve, as described more fully below. The movement of impeller 48 may be monitored by conventional circuitry or other electronic components (not shown) to detect and measure the flow rate of water through the flow meter. This, in turn, may be used to indicate leaks or an open water connection (e.g., dripping faucet) which may then be used to actuate the motor assembly 44 to close the valve and help prevent excessive water use or damage to the structure. Additionally, or in the alternative, this water meter functions to assist other sensors (for example, but not limited to, one or more pressure sensors) in determining leaks and acts to quantify a leak and, when necessary, prevents opening the valve 12 to aid in preventing excessive water use or damage to the structure. The one or more pressure sensors are used to identify and quantify a leak, based on the loss of pressure measured. It should be understood that while the preferred embodiment defines a valve that actuates with a quarter turn, other valve actuation may be capable of functional similarity and therefore are considered within the scope of the instant invention. However, there are certain benefits with the preferred embodiment that are novel in view of the prior art.

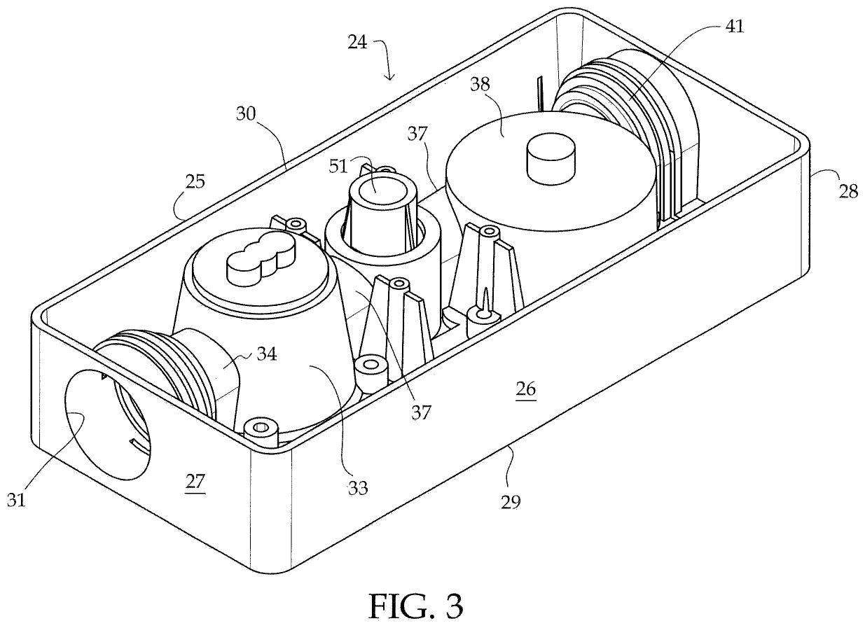

FIG. 1 also shows a preferred embodiment of pressure tank 50 which may be connected to the bottom 30 of manifold 24 in any known manner Embodiments of pressure tank 50 may be releasably affixed to manifold 24 with a screwed engagement, a quick connect fitting, a bayonet fitting, or other water-tight, frictional engagement, but such is not intended to be construed a limitation to the instant invention. Pressure tank 50 is in fluid communication with conduit 37 via port 51 (see FIG. 3) so as to maintain adequate water pressure within the structure when the valve is in an off position.

Embodiments of actuator 47 may be of any suitable type and could, for example, be energized by a remote signal from a smart phone app, or water sensor placed within the structure. Once energized, the actuator would cooperate with the motor, assembly 44 to rotate the shaft 49 and either open or close the valve, as appropriate.

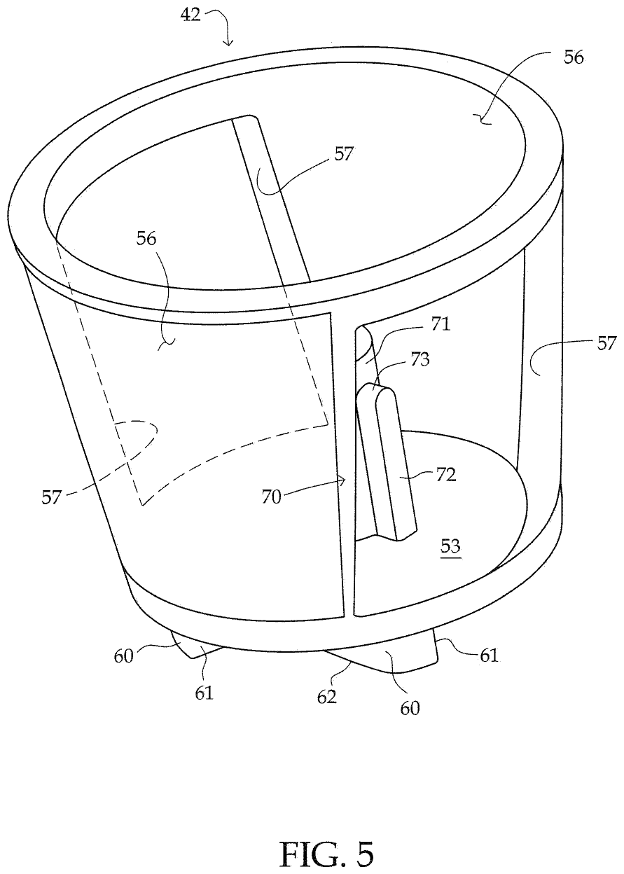

With particular reference now made to FIGS. 4 and 5, FIG. 4 shows a cross-sectional view of the preferred valve well 33 with the valve body 42 disposed therein for rotational and vertical movement. For ease of discussion, the cover 43, motor assembly 44, and actuator 47 are not shown. FIG. 5 is a perspective view, partly in phantom, of the valve body 42. Valve body 42 has two opposing solid side walls 56, 56 that are spaced from one another, defining open side walls 57, 57. In this configuration, the preferred embodiment of valve body 42 has alternating solid and open side walls. When a solid wall 56 is disposed in front of inlet port 35, the opposite solid wall 56 is disposed in front of outlet port 36, thus preventing water from passing from conduit 34 through the valve well 33 and into conduit 37. A simple turn of handle 46, for example in the preferred embodiment a quarter turn, will cause valve body 42 to rotate by a quarter turn, wherein an open side wall 57 will be positioned in front of each of inlet port 35 and outlet port 36, whereby water can freely flow through the valve.

The preferred valve body 42 is circular in plan and defines solid side walls 56, 56 and open side walls 57, 57 which are angled such that the bottom 53 of the valve body 42 is of smaller diameter than the top 54 of the valve body 42, this forming a truncated conical shaped member. The side walls 55 defining the valve well 33 are of matching angular configuration to the side walls of valve body 42 as best seen in FIG. 4.

The preferred embodiment of bottom surface 53 of the valve body 42 defines a plurality of spaced-apart, downwardly facing cam projections 60 that have a vertical face 61 and a sloped face 62. The cam ring 45, shown in FIG. 4 is positioned at the bottom of valve well 33, has similar (i.e. complementary), spaced-apart cam projections 63 that are upwardly facing and have vertical faces 64 and sloped faces 65. The preferred respective cam projections 60 on the bottom 53 of valve body 42 and cam projections 63 on cam ring 45 are sized and arranged to engage with one another as the valve body 42 is rotated. In the closed position, cam projections 60 and 63 frictionally engage, preferably forming a seal. In the open position, the seal is broken and cam projections 60 disassociate, ideally both vertically and horizontally from cam projections 63.

As the valve body 42 is rotated, the sloped faces 62 of cam projections 60 preferably frictionally engage with sloped faces 65 of cam projections 63, forcing valve body 42 to displace in the vertical plane (i.e. rise) as the valve body rotates. The rotational displacement in the circumferential direction relative to the rotation should also be understood. Subsequent rotation of the valve body 42 will result in the vertical face 61 of cam projections 60 reaching the vertical face 64 of cam projections 63, resulting in a sudden vertical displacement in the vertical plane (i.e. drop) of valve body 42. This vertical raising and lowering of the valve body 42 improves the seal between the valve body 42 and the walls 55 of the valve well 33. More specifically, when the respective cam projections reach the vertical faces, the valve body 42 will drop into the well 33. The angled surfaces of the side walls 55 of well 33 and the angled walls of the valve body 42 will form a wedge effect, forcing the side walls of the valve body 42 against the walls of the well 33 and creating a tight (ideally water tight) seal. The “breaking” of the seal formed between cam projections 60 and 63 are a novel and beneficial feature that facilitate the efficient and effective operation of valve body 42.

While the cam projections 60 are shown as being integrally formed with the valve body 42, this need not be the case. Instead, a separately formed ring or plate member having the projections may be formed and adhered or otherwise firmly connected to the bottom of the valve body 42 if desired. Similarly, the cam ring 45 is illustrated as a separate member. It will be understood that one may elect to form the cam projections integral with the bottom of valve well 33 in manifold 24 of water valve module 12, if desired.

As also seen in FIGS. 4 and 5, the valve body 42 has a generally cylindrical shaped post 70 which is centrally located on the bottom 53 of the valve body 42. The post 70 has a central cylindrical portion 71 and a pair of wing extensions 72 on opposite circumferential sides of the central portion 71. Only one such wing 72 is shown throughout the Figures. The wings 72 are shorter than the cylindrical portion 71, so as to create shoulder 73 at the upper edge of the wing projections 72. The shaft 49 has a central stem portion 74. Handle 46 is attached to a proximal end of the stem 74 and a saddle member 75 is attached to the distal end of the stem 74. The saddle member 75 is a hollow cylindrical member with a pair of slots 76 located on opposite circumferential walls (see also FIG. 1). The saddle member 75 is sized to fit over the central cylindrical portion 71 of post 70, with wing extensions 72 being received within the respective slots 76. In this arrangement, rotational movement of handle 46, or stem 74, will cause a likewise rotational movement of saddle 75 and corresponding rotation of valve body 42. It will be appreciated by those skilled in the art that other arrangements to transmit rotational movement to the valve body 42 may also be employed if desired.

While the valve module 24 may be used to control the flow of water into a structure, in a preferred embodiment the valve module will be used in conjunction with the main water shut-off for the structure. More specifically, it is preferable that the valve module, and water filtration module, if used, be introduced into the main water supply line between the primary water shut-off valve and the fixtures and appliances within the structure that use water, whereby the valve module would act as a secondary shut-off for the water supply.

The illustrations and examples provided herein are for explanatory purposes and are not intended to limit the scope of the appended claims.

I claim:

1. A water control device comprising a valve module, the valve module comprising a manifold having an inlet port; a valve well in fluid communication with the inlet port; an outlet port in fluid communication with the valve well; and a valve body disposed within said valve well for rotational movement between open and closed positions to alternately open or close the fluid communication between the inlet port and outlet port of said manifold; wherein upon rotation of said valve body, said valve body is displaced in a vertical plane.

2. The water control device of claim 1, further comprising a water filtration module, said water filtration module having a filtration inlet port, a filtration outlet port and a filtration cartridge port in fluid communication with both the filtration inlet port and filtration outlet port; wherein said filtration outlet port is in fluid communication with the inlet port of said valve module.

3. The water control device of claim 1, further comprising a pressure tank in fluid communication with the valve well and the outlet port.

4. The water filtration device of claim 1, further comprising a flow meter well in fluid communication with the valve well and the outlet port, and an impeller disposed for rotational movement within said flow meter well to detect and measure the flow of water through said module.

5. The water control device of claim 1, wherein the valve well has sloped side walls such that a diameter of a bottom of said well is smaller than a diameter of a top of said well.

6. The water control device of claim 1, wherein the valve well has sloped side walls such that a diameter of a bottom of said well is smaller than a diameter of a top of said well; wherein said valve body comprises a truncated cone shaped member having a top, a bottom and sloped side walls wherein a diameter of the bottom of said valve body is smaller than a diameter of the top of said well body.

7. The water control device of claim 1, wherein said valve body comprises a truncated cone shaped member having a top, a bottom and sloped side walls, wherein a diameter of the bottom of said valve body is smaller than a diameter of the top of said valve body; wherein said valve body has two opposing solid side walls that are spaced from one another, and two opposing open side walls, said open side walls alternating with said solid side walls to define an outer circumferential surface of said valve body.

8. The water control device of claim 1, wherein said valve body has downwardly projecting cam surfaces cooperating with upwardly projecting cam surfaces on a bottom of said valve well to cause vertical displacement of the valve body as the valve body is rotated.

9. The water control device of claim 1, wherein said valve body has downwardly projecting cam surfaces cooperating with upwardly projecting cam surfaces on a bottom of said valve well to cause vertical displacement of the valve body as the valve body is rotated; wherein said downwardly projecting cam surfaces are formed integral with a bottom of said valve body.

10. The water control device of claim 1, wherein said valve body has downwardly projecting cam surfaces cooperating with upwardly projecting cam surfaces on a bottom of said valve well to cause vertical displacement of the valve body as the valve body is rotated; wherein said upwardly projecting cam surfaces comprise a cam ring fixedly secured to a bottom of the valve well.

11. The water control device of claim 1, wherein said valve body has downwardly projecting cam surfaces cooperating with upwardly projecting cam surfaces on a bottom of said valve well to cause vertical displacement of the valve body as the valve body is rotated; wherein the downwardly projecting cam surfaces comprise a vertical face and a sloped face.

12. The water control device of claim 1, wherein said valve body has downwardly projecting cam surfaces cooperating with upwardly projecting cam surfaces on a bottom of said valve well to cause vertical displacement of the valve body as the valve body is rotated; wherein the upwardly projecting cam surfaces comprise a vertical face and a sloped face.

13. The water control device of claim 1, wherein said valve body has downwardly projecting cam surfaces cooperating with upwardly projecting cam surfaces on a bottom of said valve well to cause vertical displacement of the valve body as the valve body is rotated; wherein said downwardly projecting cam surfaces are formed integral with a bottom of said valve body; wherein said upwardly projecting cam surfaces comprise a cam ring fixedly secured to a bottom of the valve well; wherein the downwardly projecting cam surfaces comprise a vertical face and a sloped face and wherein the upwardly facing cam surfaces comprise a vertical face and a sloped face.

14. The water control device of claim 1, wherein said valve body comprises a truncated cone shaped member having a top, a bottom and sloped side walls, wherein a diameter of the bottom of said valve body is smaller than a diameter of the top of said valve body; wherein said valve body has two opposing solid side walls that are spaced from one another, and two opposing open side walls, said open side walls alternating with said solid side walls to define an outer circumferential surface of said valve body; wherein said valve body has downwardly projecting cam surfaces cooperating with upwardly projecting cam surfaces on a bottom of said valve well to cause vertical displacement of the valve body as the valve body is rotated; wherein said downwardly projecting cam surfaces are formed integral with a bottom of said valve body; wherein said upwardly projecting cam surfaces comprise a cam ring fixedly secured to a bottom of the valve well; wherein the downwardly projecting cam surfaces comprise a vertical face and a sloped face and wherein the upwardly facing cam surfaces comprise a vertical face and a sloped face.

15. The water control device of claim 1, wherein said valve body further comprises a central post upwardly projecting from a bottom of said valve body, said post having a cylindrical portion and a pair of opposed wings outwardly projecting from the central portion.

16. The water control device of claim 1, wherein said valve body further comprises a central post upwardly projecting from a bottom of said valve body, said post having a cylindrical portion and a pair of opposed wings outwardly projecting from the central portion, said wings being shorter than said cylindrical portion so as to form a shoulder between the wings and the cylindrical portion.

17. The water control device of claim 1, wherein said valve body further comprises a central post upwardly projecting from a bottom of said valve body, said post having a cylindrical portion and a pair of opposed wings outwardly projecting from the central portion, said wings being shorter than said cylindrical portion so as to form a shoulder between the wings and the cylindrical portion; said water control device further comprising a shaft, said shaft having a stem with a proximal end and a distal end, a handle connected to said proximal end of said stem and a saddle connected to said distal end of said stem; said saddle having a hollow cylindrical shape with slots located on opposed circumferential walls of the saddle; the saddle being is sized to fit over the cylindrical portion of the post with wing projections being received within the respective slots.

18. The water control device of claim 1, wherein the valve body is rotated manually.

19. The water control device of claim 1, wherein the module is connected to a main water supply line independent of a main water shut-off valve for a structure.
